(19) United States
(12) Patent Application Publication
(10) Pub. No.: US 2013/0173491 A1
(43) Pub. Date: Jul. 4, 2013

(54) HIGHLIGHTING GUEST REVIEWS

(71) Applicants: Gregory M. Nations, Minneapolis, MN (US); Chad R. Gourley, Elk River, MN (US); Sarah Jellison, Minneapolis, MN (US); Sarah Peterson, Minneapolis, MN (US); Stephen Hopf, Brooklyn, NY (US)

(72) Inventors: Gregory M. Nations, Minneapolis, MN (US); Chad R. Gourley, Elk River, MN (US); Sarah Jellison, Minneapolis, MN (US); Sarah Peterson, Minneapolis, MN (US); Stephen Hopf, Brooklyn, NY (US)

(73) Assignee: TARGET BRANDS, INC., Minneapolis, MN (US)

(21) Appl. No.: 13/339,164

(22) Filed: Dec. 28, 2011

(51) Int. Cl. G06Q 30/00

(52) U.S. Cl. 705/347

(57) ABSTRACT

A processor determines that a user who has requested that a list of reviews be displayed is the same user who had previously submitted a review found in the list of reviews. The processor displays the review submitted by the user and at least one additional review from another user so as to highlight the review submitted by the user relative to the at least one additional review in response to the determination that the user who submitted the review is the same user who requested that the list of reviews be displayed.

### BACKGROUND

On retail websites, products are presented for sale by showing images of the products and text describing the products. In addition, may websites provide reviews of the product that are generated by either a professional reviewer or by visitors to the web site who have purchased the product. The reviews typically include a rating such as “three stars” and text that describes the advantages and disadvantages of the product as well as an identifier of who wrote the review.

The discussion above is merely provided for general background information and is not intended to be used as an aid in determining the scope of the claimed subject matter. The claimed subject matter is not limited to implementations that solve any or all disadvantages noted in the background.

### SUMMARY

A processor determines that a user who has requested a list of reviews is the same user who had previously submitted a review found in the list of reviews. The processor displays the review submitted by the user and at least one additional review from another user so as to highlight the review submitted by the user relative to the at least one additional review in response to the determination that the user who submitted the review is the same user who requested the list of reviews.

In accordance with a further embodiment, a memory stores a review of a product that was sent by a first user and a review of the product that was sent by a second user. A processor determines that the review of the product sent by the first user should be displayed in a different manner relative to the review of the product sent by the second user based on a determination that the first user has requested that reviews of the product be displayed. The processor also causes the review of the product sent by the first user to be displayed relative to the review of the product sent by the second user in the determined manner.

In accordance with a still further embodiment, instructions are served to a client to display a review received from a user and at least one additional review received from another person so as to highlight the review received from the user relative to the at least one additional review in response to a request for a page being made under a credential assigned to the user.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is flow diagram of a process in accordance with one embodiment.

FIG. 2 is a block diagram of elements used in the flow diagram of FIG. 1.

FIG. 3 is a view of a display showing reviews when the user who requested the review page does not match any of the users who sent the reviews.

FIG. 4 is a view of a display showing a user's review that is highlighted by changing the background behind the review.

FIG. 5 is a view of a display showing a user's review that is highlighted by bolding the text of the review relative to other reviews.

FIG. 6 is a view of a display showing a user's review that is highlighted by using a larger font relative to other reviews.

FIG. 7 is a view of a display showing a user's review that is highlighted by placing the review above reviews by other users.

FIG. 8 is a view of a display showing a login window after a user has selected a link to write a review.

FIG. 9 is view of a display showing a review editing window after the user has selected a link to write a review and has been signed in.

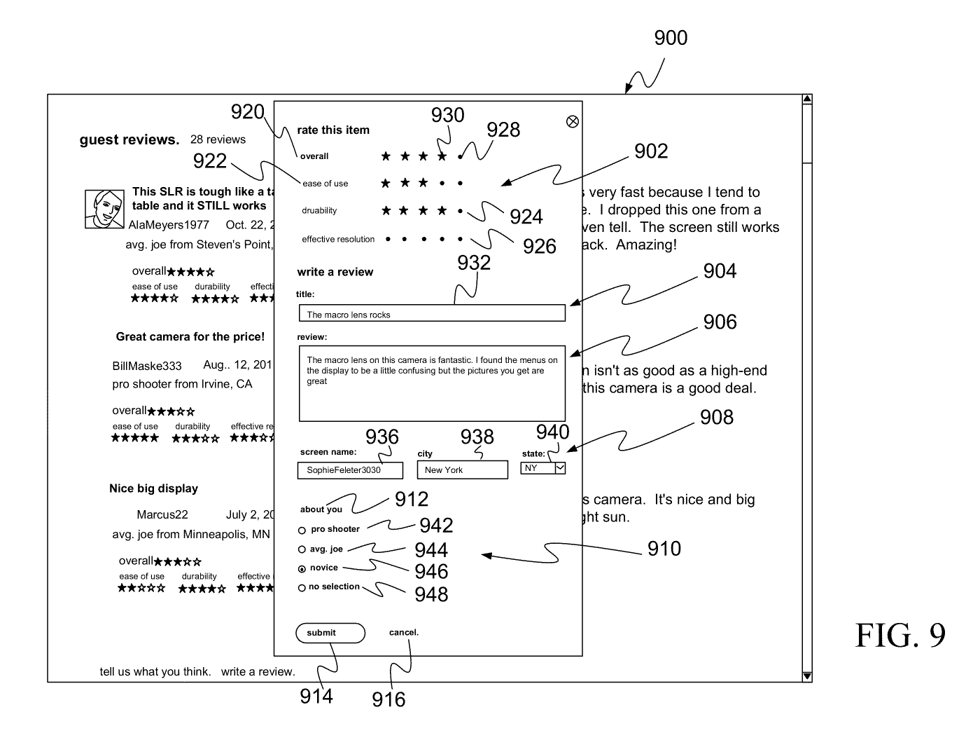

FIG. 10 is a block diagram of a server-client environment.

FIG. 11 is a block diagram of a computing device.

### DETAILED DESCRIPTION

In the embodiments discussed below, a user's review is provided in a list of reviews. The user's review is highlighted in the list if the user requested to see the list of reviews. If a different user requested to see the list of reviews, the user's review would not be highlighted. Highlighting a review can include making the review appear differently than other displayed reviews by, for example, using a different background color for the review, using a different font size for the review, or bolding the review without bolding the other reviews. In addition, links on the page providing the list of reviews change if the user who requested the page also submitted one of the reviews on the page. Specifically, a link to write a review is removed if the requesting user submitted one of the reviews in the list of reviews. Further, links to add a photo of the user or links to add other images or video to the review submitted by the user may be added to the review that was submitted by the user.

In the context of this innovation, reviews are written statements, audio commentary, audio/visual commentary, drawings and/or images that convey a user's opinion about a person, place or thing. The reviews can be of restaurants, stores, movies, events, products, services and/or service providers, for example.

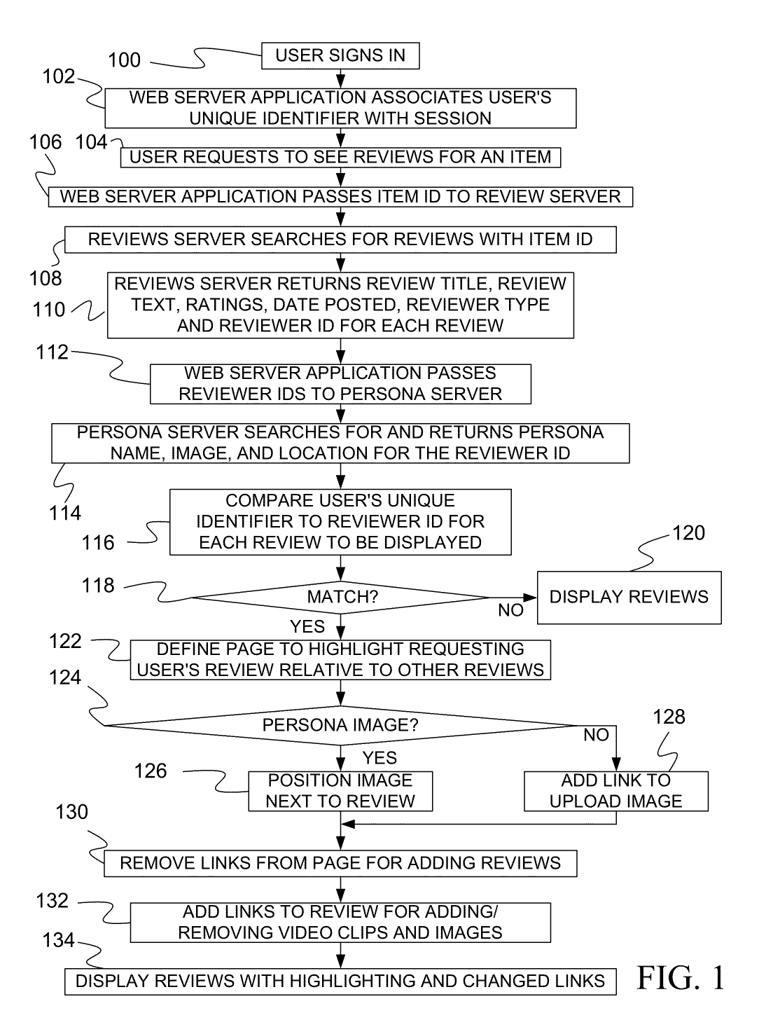

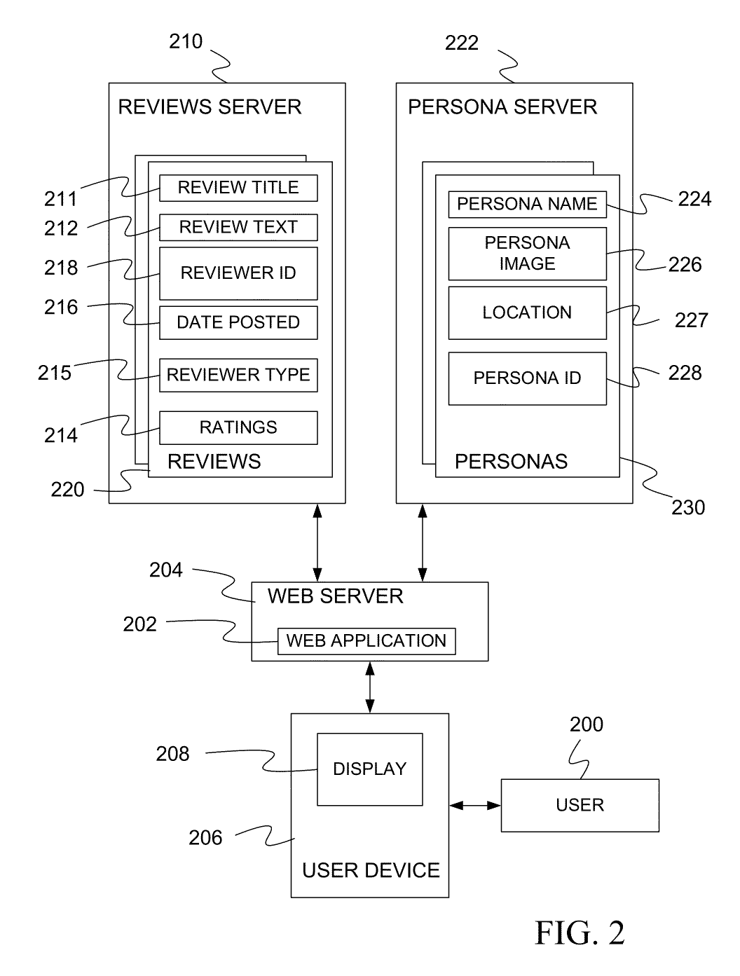

FIG. 1 provides a flow diagram of a method in accordance with one embodiment and FIG. 2 provides elements used in the method of FIG. 1. In step 100, a user 200 signs into a web server application 202 on a web server 204 using a user device 206, such as a mobile device, a tablet computer, a laptop computer or a desk top computer, for example. Signing in typically involves providing a unique username and a password or other form of authentication where the unique username is a form of user credential.

At step 102, web server application 202 associates a unique identifier for the user with a session identifier (session ID). The session ID is a server-side identifier that is used to group different requests to the web server as coming from a single client device. The session ID allows the web server to save state information, such as the user's unique identifier, and to use that state information with later web page requests made during the same session. The session ID may be stored on the client device as a “cookie”, which is a small data file. Alternatively, the web server may alter each page it serves to embed the session ID in all web address links on the page. When a link is selected, the session ID is automatically sent back to the web server as part of the web address.

At step 104, the user requests reviews for an item. This request may be an explicit request for reviews of a particular item, an explicit request for multiple items, or simply a request for a details page of an item, which is interpreted as a request for reviews of the item. The item may comprise any item that users can review such as a product, service, event, location, restaurant, store, or movie, for example. The request for reviews is communicated to web server application 202, and web server application 202 passes an item identifier (item ID) for the selected item to a Reviews Server 210 in a request for reviews of the item at step 106. Reviews Server 210 searches for reviews of the item using the item ID at step 108. At step 110, Review Server 210 returns to web server application 202 a review title 211, a review text 212, ratings 214, a reviewer type 215, a date posted 216, and a reviewer ID 218 for each review of the selected item in a set of reviews 220.

At step 112, web server application 202 passes each of the reviewer IDs to a Persona Server 222, which contains persona records 230 for users of web application 202 that include a persona name 224 for each user, a persona image 226 for each user, a location 227 for each user, and a persona ID 228 for each user. Persona name 224 is a name that is to be displayed by web application 202 when referring to the user. Persona name 224 does not have to be the actual name of the person but instead may be any name that the user wants to represent them on the site. Persona image 226 is an image file that contains an image that can be displayed by application 202 when referring to the user. Persona image 226 does not have to be an actual image of the user but instead may be any image that the user has selected to represent them on the site. Location 227 is a geographical location selected by the user. In accordance with one embodiment, location 227 is a city and state where the user lives or works, for example. Persona ID 228 is a unique identifier for the user and is the same as the reviewer ID 218 in accordance with some embodiments.

At step 114, Persona Server 222 searches persona records 230 for personas that have a persona ID 228 that matches one of the reviewer IDs passed to Persona Server 222 at step 112. For each persona record that has a matching persona ID, Persona Server 222 retrieves the persona name 224, the persona image 226 (if any), and the location 227.

At step 116, web server application 202 compares the unique identifier of the user that was associated with the session at step 102 to each of the reviewer IDs 218 provided by Reviews Server 210. If the unique identifier of the user does not match any of the reviewer IDs 218 returned by Reviews Server 210 at step 118, web server application 202 returns a page to user device 206 at step 120. The page returned at step 120 includes the review text 212, date posted 216, ratings 214, persona name 224, persona image 226 (if any) and the location 227 associated with one or more of the reviews returned by Reviews Server 210. Since none of the reviews returned by Reviews Server 210 have a reviewer ID 218 that matches the unique identifier of the user who requested the reviews, the returned page will not include a review written by the user who requested the reviews. As such, the page will not include a review that is highlighted because it was written by the user who requested the reviews. Note that if the user who requested the reviews did not sign in at step 100 before requesting the reviews, web server application 202 will not be able to match the user's unique identifier at step 118, and the reviews will be displayed in step 120 as discussed above.

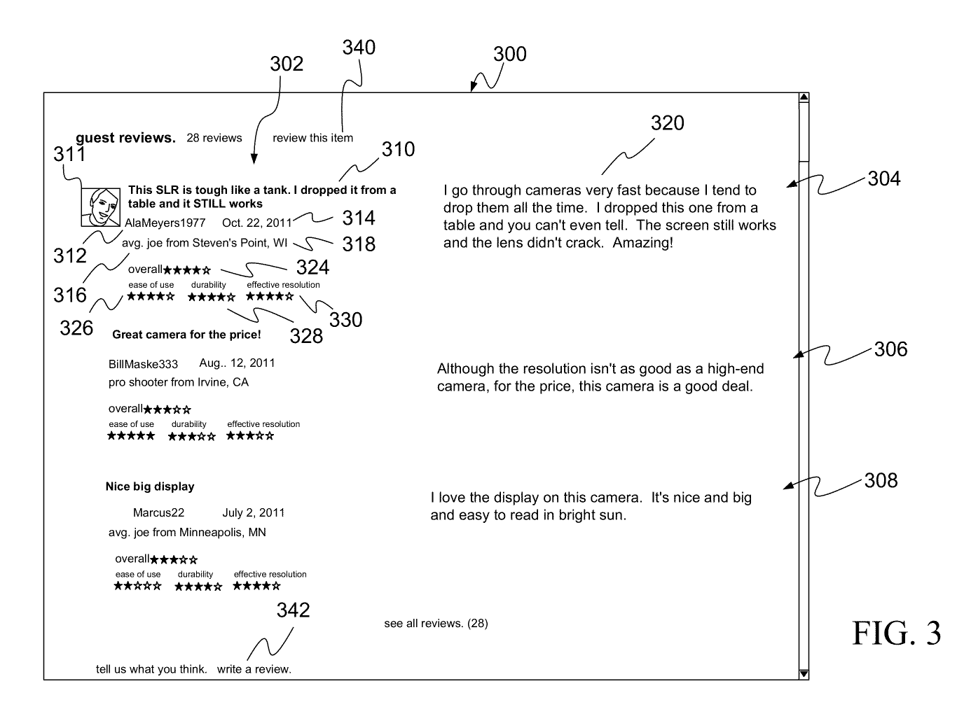

FIG. 3 provides an example of a displayed page 300 showing a list of reviews 302 that include reviews 304, 306 and 308. None of the reviews 304, 306, and 308 were submitted by the requester of the list of reviews 302 at step 104 and as such, none of the reviews are highlighted relative to the other reviews. Review 304 includes a title 310, a persona image 311, a persona name 312 of the reviewer, a posted date 314 for the review, a reviewer type 316 for the reviewer and a location 318 for the persona. Review 304 also includes review text 320 and ratings 322 that include overall rating 324, ease of use rating 326, durability rating 328 and effective resolution 330. Reviews 306 and 308 include similar elements as review 304 but do not include the equivalent of reviewer image 311. Title 310, posted date 314, reviewer type 316, review text 320 and ratings 322 are each provided by Reviews Server 210. Persona image 311, persona name 312, and location 318 are each provided by Persona Server 222.

Because review list 302 does not include a review from the requester, page 300 also includes links 340 and 342 that allow a user to write a review.

If the unique identifier of the user who requested the list of reviews matches the reviewer ID of one of the reviews in the list of reviews at step 118, the user's review is highlighted relative to other reviews when presenting the list of reviews at step 122.

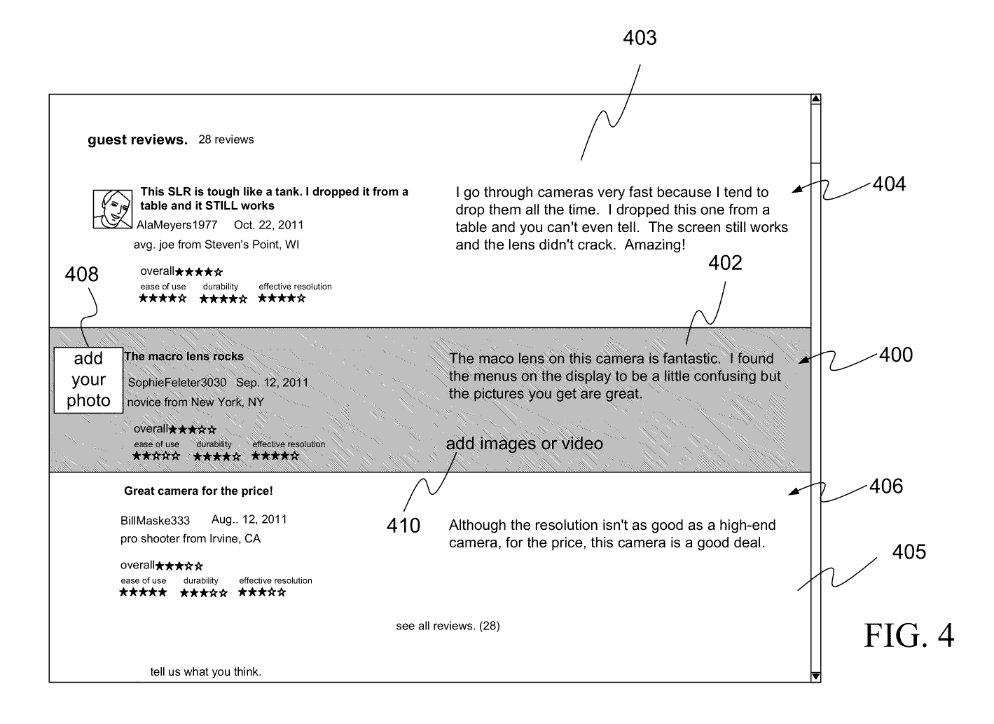

Highlighting the review of the user who requested the list of reviews involves making the review stand out on the displayed page. In accordance with one embodiment and as shown in FIG. 4, highlighting a review 400 of the user who requested the list of reviews involves designating a different background 402 for review 400 than backgrounds 403 and 405 of other reviews 404 and 406. For example, reviews 404 and 406, which were generated by other users, are designated as being over white backgrounds 403 and 405 while review 400 is designated as being over a darker background 402 such as a blue background or a grey background, for example. The darker background may be either a color background or a gray scale background. Further, the different background may be a patterned background with a different pattern than the background for reviews 404 and 406.

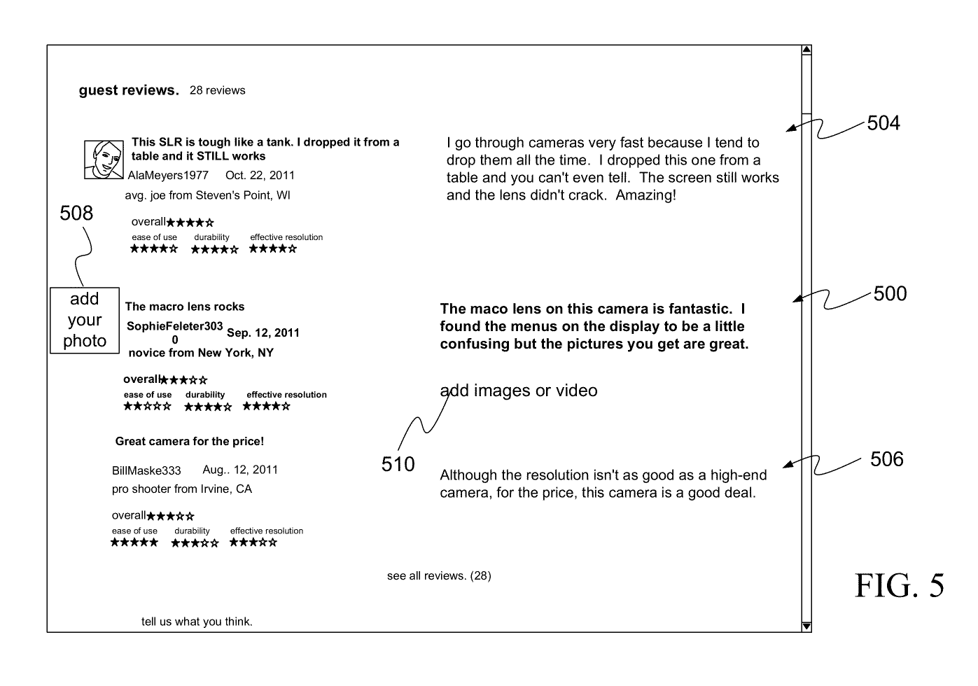

In accordance with another embodiment and as shown in FIG. 5, highlighting a review 500 of the user who requested the list of reviews involves designating the text of review 500 as being in a bolded, darker or thicker font than other reviews 504 and 506. For example, reviews 504 and 506, which were generated by other users, are designated as being in a non-bolded font while review 500 is designated as being in a bolded font. In the embodiment of FIG. 5, the same types of font and the same sizes of font are used in all of reviews 500, 504, and 506. However, those skilled in the art will recognize that different font types and different font sizes may be used in conjunction with using a bolded font for review 500 and a non-bolded font for reviews 504 and 506.

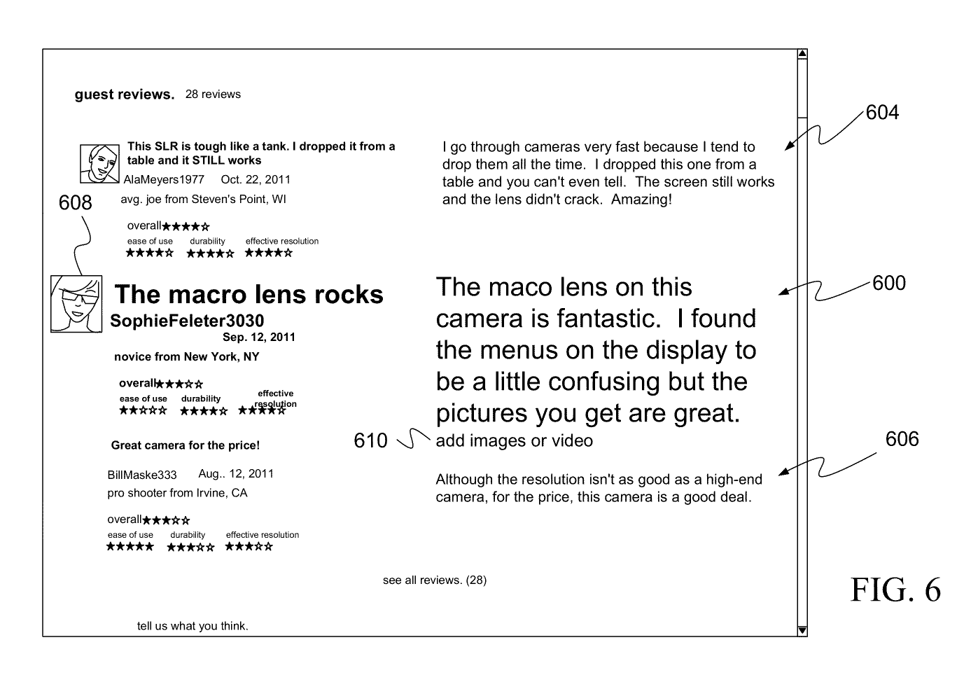

In accordance with another embodiment and as shown in FIG. 6, highlighting a review 600 of the user who requested the list of reviews involves designating the review 600 in a different-sized font, for example a larger font, than other reviews 604 and 606. For example, reviews 604 and 606, which were generated by other users, can be designated as twelve-point fonts while review 600 is designated as an eighteen-point font.

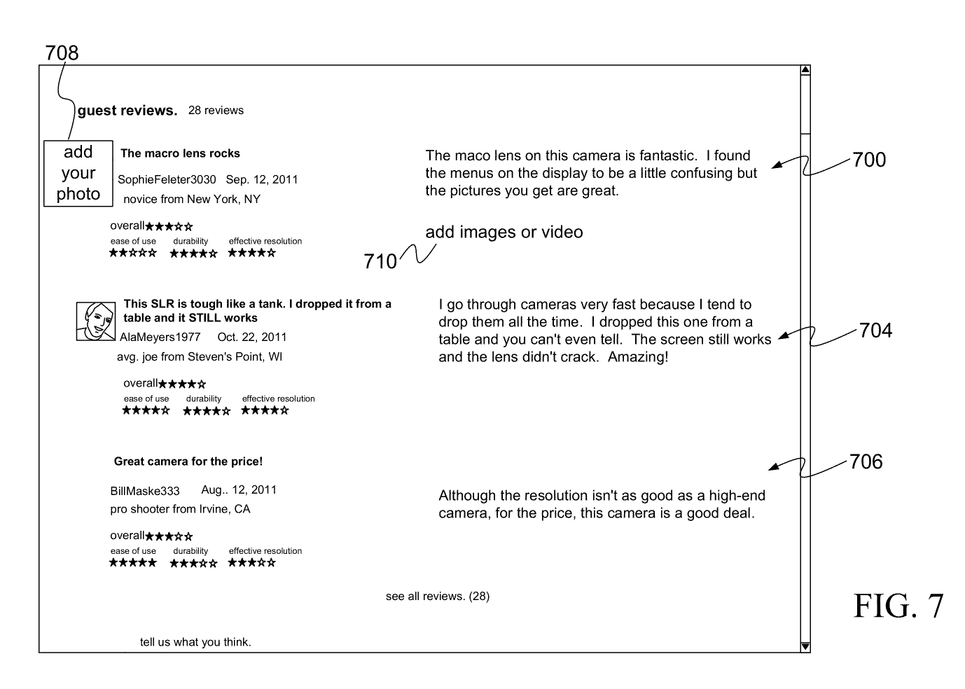

In accordance with another embodiment and as shown in FIG. 7, highlighting a review 700 of the user who requested the list of reviews involves defining the layout of reviews so that the review 700 is above or higher than reviews 704 and 706 from other users regardless of when review 700 was posted by the user and regardless of the ratings in review 700. Thus, even though the user provided review 700 between when reviews 704 and 706 where posted, it is designated as being on top of reviews 704 and 706 even though all other reviews are ordered based on the date they were posted. Similarly, even though review 700 provides the same rankings as review 706, review 700 is designated as being on top of review 704, which provides a different ranking, and apart from review 706.

Although FIGS. 4-7 show the displayed results that are achieved based on the highlighting designations provided by web application 202 at step 122, it should be understood that the reviews are not displayed at step 122 and that further steps are performed as discussed below before web application 202 provides a web page with a highlighted review to user device 206.

At step 124, the processor executing web applications 202 determines if a persona image 226 of the user who requested the list of reviews was returned by persona server 222 at step 114. If persona server 222 returned a persona image, it is positioned next to the review at step 126. An example of a displayed persona image 608 is shown in FIG. 6. If a persona image was not returned by persona server 222, a link to add a persona image is positioned next to the review at step 128. Examples of links to add a persona image are shown as links 408, 508, and 708 in FIGS. 4, 5 and 7, respectively.

At step 130, links for adding a review are removed from the page displaying the list of reviews in response to the determination that the unique identifier of the user who requested the list of reviews matches the reviewer ID of one of the reviews. The links for adding a review are removed to prevent users from uploading more than one review. In accordance with one embodiment, removing the links to add a review involves removing links such as links 340 and 342 of FIG. 3, which are not present in FIG. 4, 5, 6 or 7. In accordance with one embodiment, the links are removed at step 130 by web application 202 not inserting such links in the page. Thus, step 130 may involve using code in web application 202 to define the review page such that it does not include a link to add a review.

At step 132, the processor executing web application 202 adds links to the review page near the review to allow the user to add or remove images and/or videos that are displayed with the review. Examples of such links are shown as links 410, 510, 610, and 710 of FIGS. 4, 5, 6, and 7, respectively. Selecting one of the links causes a window or another page (not shown) to be displayed in which a user may upload image or video files or remove previously uploaded image or video files. Thumbnails of the uploaded images and videos are displayed next to the review and when selected provided an enlarged view of the image or an enlarged video player that plays the video.

At step 134, the list of reviews is displayed with the highlighting and the altered links discussed above.

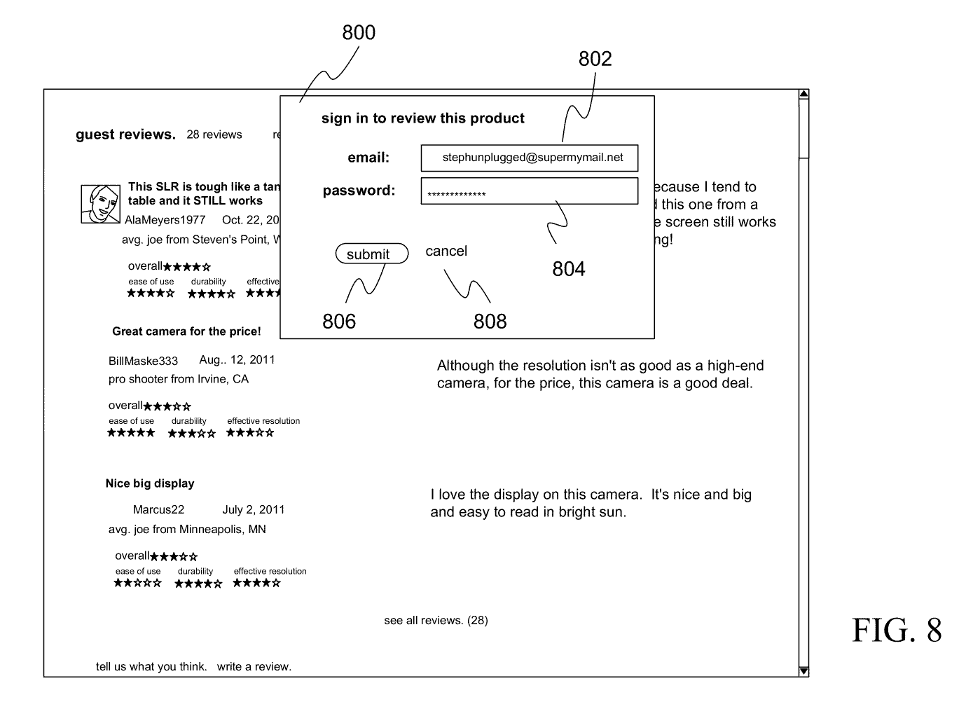

As noted above, if a user has not signed in at step 100, web application 202 cannot match the user's unique identifier to any of the reviewer IDs returned by Reviews Server 210. As a result, web application 202 will return a web page such as the page shown in FIG. 3 with links 340 and/or 342 for adding a review. FIG. 8 shows a window 800 that opens in response to the selection of either link 340 or link 342 if the user has not signed in. Window 800 is a sign-in window that prompts the user to sign into web application 202. In particular, window 800 provides a space 802 for the user to enter their e-mail address and a space 804 for the user to enter their password. In accordance with one embodiment, the e-mail address entered in space 802 represents the username of the user. Window 800 also includes a submit button 806 that allows the user to submit the e-mail address and the password to web application 202 for authentication and a cancel button 808 to cancel the authentication process.

Upon receiving the e-mail address and password, web application 202 verifies that there is an existing account with these credentials and retrieves a unique identifier for the user. In accordance with some embodiments, the unique identifier for the user is the e-mail address that was provided by the user. The web application then associates the user's unique identifier with the current session ID.

After the user has signed in, a review editing window 900 opens that includes a ratings area 902, a title area 904, review text area 906, screen name area 908, location area 910, “about you” area 912, submit button 914 and cancel button 916. Ratings area 902 includes overall rating area 920, ease of use area 922, durability area 924 and effective resolution area 926. Each of areas 920, 922, 924 and 926 include selectable dot icons such as dot icon 928 that when selected by a user changes into a selectable star, such as selectable star 930. By selecting the selectable dot icons, a user is able to assign a star rating to each of the rating areas 920, 922, 924, and 926. By selecting a selectable star, the user is able to remove the star from the rating and turn it back into a selectable dot.

Title area 904 includes a text box 932 in which the user may enter a title for their review. Review text area 906 includes a text box 934 in which the user may enter the text of their review. Screen name area 908 includes a text box 936 in which the user may enter a name that will appear with the review. The name provided in text box 936 may be different than the e-mail address entered in textbox 802 of FIG. 8. In accordance with most embodiments, the name entered in screen name area 908 will be the persona name 224 stored on persona server 222. Location area 910 includes city text box 938 in which the user may enter the city they live in and state text box 940 in which the user may enter the state they live in. “About you” area 912 includes selectable radio buttons 942, 944, 946 and 948 that allow the user to select a reviewer type 215 that describes them.

When the user presses the submit button, the review is submitted to web application 202. Web application 202 then sends the review text, title text, reviewer type, ratings, date posted, and the user's unique identifier to reviews server 210, where it is stored in memory. In accordance with some embodiments, the user is presented with a preview of the review before it is submitted for storage at the server.

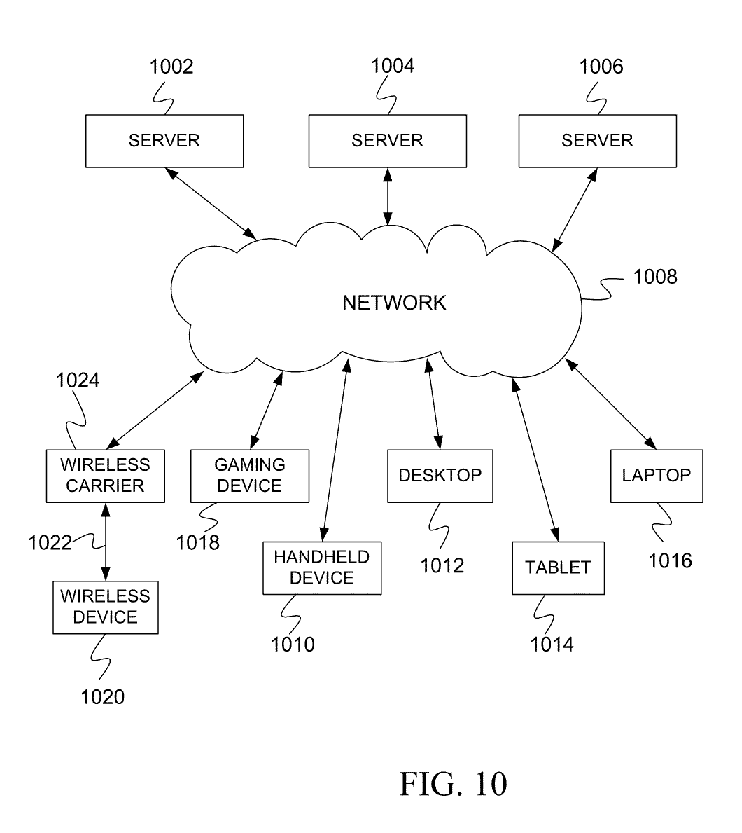

FIG. 10 provides a block diagram of a network environment which embodiments of the present invention may be practiced. In FIG. 10, a collection of servers 1002, 1004 and 1006 store one or more webpages that can be requested by client devices through a network 1008. Such networks can include the Internet or other wide area networks or an intranet or other local area networks. Client devices can include, for example, handheld device 1010, desktop 1012, tablet 1014, laptop 1016, gaming device 1018 or a wireless device 1020. Wireless device 1020, including such devices as cellular phones, can request webpages through a cellular connection 1022 to a wireless carrier 1024, which is connected to the network 1008. The client devices listed for FIG. 10 are examples of available client devices and other client devices that are capable of connecting through a network 1008 to one or more servers 1002, 1004 and 1006 can be used with the present invention.

Communication along network 1008 can utilize one or more protocols including Hypertext Transfer Protocol (http), Transmission Control Protocol/Internet Protocol (TCP/IP) and the like. The web pages provided by servers 1002, 1004 and 1006 may be written in a mark-up language such as Hypertext Markup Language (HTML) or Extensible Markup Language (XML) and may utilize one or more Cascade Style Sheets. In addition, the web pages provided by servers 1002, 1004 and 1006 may use one or more scripts for rendering the page including for example JavaScript®, from Oracle Corporation.

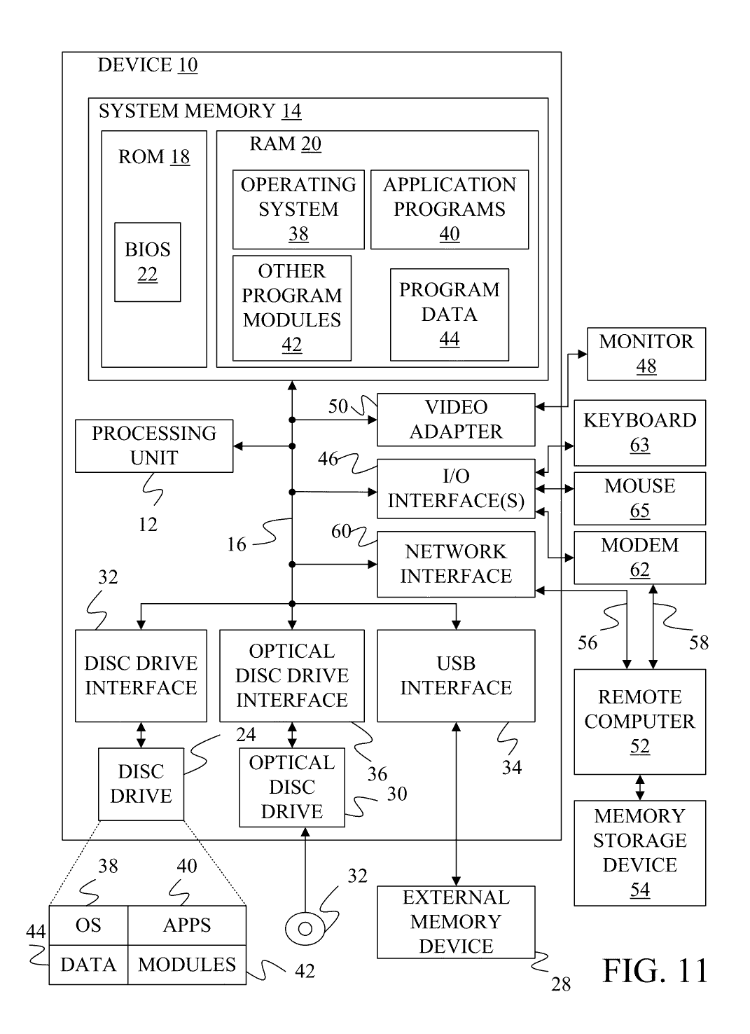

An example of a computing device that can be used as a server and/or client device in the various embodiments is shown in the block diagram of FIG. 11. The computing device 10 of FIG. 11 includes a processing unit or processor 12, a system memory 14 and a system bus 16 that couples the system memory 14 to the processing unit 12. System memory 14 includes read only memory (ROM) 18 and random access memory (RAM) 20. A basic input/output system 22 (BIOS), containing the basic routines that help to transfer information between elements within the computing device 10, is stored in ROM 18. Computer-executable instructions that are to be executed by processing unit 12 may be stored in random access memory 20 before being executed.

Embodiments of the present invention can be applied in the context of computer systems other than computing device 10. Other appropriate computer systems include handheld devices, multi-processor systems, various consumer electronic devices, mainframe computers, and the like. Those skilled in the art will also appreciate that embodiments can also be applied within computer systems wherein tasks are performed by remote processing devices that are linked through a communications network (e.g., communication utilizing Internet or web-based software systems). For example, program modules may be located in either local or remote memory storage devices or simultaneously in both local and remote memory storage devices. Similarly, any storage of data associated with embodiments of the present invention may be accomplished utilizing either local or remote storage devices, or simultaneously utilizing both local and remote storage devices.

Computing device 10 further includes a hard disc drive 24, an external memory device 28, and an optical disc drive 30. External memory device 28 can include an external disc drive or solid state memory that may be attached to computing device 10 through an interface such as Universal Serial Bus interface 34, which is connected to system bus 16. Optical disc drive 30 can illustratively be utilized for reading data from (or writing data to) optical media, such as a CD-ROM disc 32. Hard disc drive 24 and optical disc drive 30 are connected to the system bus 16 by a hard disc drive interface 32 and an optical disc drive interface 36, respectively. The drives and external memory devices and their associated computer-readable media provide nonvolatile storage media for the computing device 10 on which computer-executable instructions and computer-readable data structures may be stored. Other types of media that are readable by a computer may also be used in the exemplary operation environment.

A number of program modules may be stored in the drives and RAM 20, including an operating system 38, one or more application programs 40, other program modules 42 and program data 44. In particular, application programs 40 can include server instructions that handle requests for web pages from a client, retrieve the content of the web pages, define the layout of the web page and serve the web pages to the client when the computing device is used as a server. When the computing device is used as a client, application programs 40 can include a web browser that receives, interprets and renders one or more of the web pages described above. Such web browsers include script interpreters that are able to interpret script code in the web pages including script code that performs one or more of the steps of FIG. 1. The combination of the web browser and any script code in the web page can be considered computer-executable instructions that are stored on a computer-storage medium for execution by a processor. Program data 44 may include images, video, audio and text that form one or more of the web pages including video and images associated with a review including a photo of the user, video posted with a review, and images posted with a review. In addition, program data 44 can include the unique identifier of the user who requested the list of reviews as well as the unique identifiers associated with each review.

Input devices including a keyboard 63 and a mouse 65 are connected to system bus 16 through an Input/Output interface 46 that is coupled to system bus 16. Monitor 48 is connected to the system bus 16 through a video adapter 50 and provides graphical images to users. Other peripheral output devices (e.g., speakers or printers) could also be included but have not been illustrated. In accordance with some embodiments, monitor 48 comprises a touch screen that both displays input and provides locations on the screen where the user is contacting the screen.

The computing device 10 may operate in a network environment utilizing connections to one or more remote computers, such as a remote computer 52. The remote computer 52 may be a server, a router, a peer device, or other common network node. Remote computer 52 may include many or all of the features and elements described in relation to computing device 10, although only a memory storage device 54 has been illustrated in FIG. 11. The network connections depicted in FIG. 11 include a local area network (LAN) 56 and a wide area network (WAN) 58. Such network environments are commonplace in the art.

The computing device 10 is connected to the LAN 56 through a network interface 60. The computing device 10 is also connected to WAN 58 and includes a modem 62 for establishing communications over the WAN 58. The modem 62, which may be internal or external, is connected to the system bus 16 via the I/O interface 46.

In a networked environment, program modules depicted relative to the computing device 10, or portions thereof, may be stored in the remote memory storage device 54. For example, application programs may be stored utilizing memory storage device 54. In addition, data associated with an application program, such as data stored in the databases or lists described above, may illustratively be stored within memory storage device 54. It will be appreciated that the network connections shown in FIG. 11 are exemplary and other means for establishing a communications link between the computers, such as a wireless interface communications link, may be used.

Processor/processing unit 12 executes computer-executable instructions to perform the steps described above. In particular, the processor serves instructions to a client to display a review received from a user and at least one additional review received from another person so as to highlight the review received from the user relative to the at least one additional review in response to a request for a page being made under a credential assigned to the user. Further, the processor serves instructions to use a different colored background when displaying the review received from the user than when displaying the at least one additional review received from another person. The processor also serves instructions to the client so that a link to add a review is not displayed with the review received from the user. The processor can also serve instructions to the client to display the review received from the user in a darker font than at least one additional review received from another person.

In accordance with other embodiments, processor/processing unit 12 determines that a review of a product sent by a first user should be displayed in a different manner relative to a review of the product sent by a second user based on a determination that the first user has requested that reviews of the product be displayed. Further, the processor/processing unit 12 causes the review of the product sent by the first user to be displayed relative to the review of the product sent by the second user in the determined manner.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer storage medium having computer executable instructions that when executed by a processor cause the processor to perform steps comprising:
determining that a user who has requested that a list of reviews be displayed is the same user who had previously submitted a review in the list of reviews; and
displaying the review submitted by the user and at least one additional review from another user so as to highlight the review submitted by the user relative to the at least one additional review in response to the determination that the user who submitted the review is the same user who requested that the list of reviews be displayed.

2. The computer storage medium of claim 1 wherein displaying the review submitted by the user and at least one additional review from another user so as to highlight the review submitted by the user relative to the at least one additional review comprises displaying the review submitted by the user in larger font than the at least one additional review.

3. The computer storage medium of claim 1 wherein displaying the review submitted by the user and at least one additional review from another user so as to highlight the review submitted by the user relative to the at least one additional review comprises displaying the review submitted by the user above the at least one additional review regardless of an order in which reviews were received.

4. The computer storage medium of claim 1 wherein displaying the review submitted by the user and at least one additional review from another user so as to highlight the review submitted by the user relative to the at least one additional review comprises displaying the review submitted by the user over a different background than the at least one additional review.

5. The computer storage medium of claim 1 further comprising displaying the review submitted by the user and at least one additional review from another user without displaying a link to add a review.

6. The computer storage medium of claim 1 further comprising:
receiving a review from a client;
identifying a user credential under which the review was received;
storing the review such that the review is associated with the user credential.

7. The computer storage medium of claim 1 wherein displaying the review submitted by the user and at least one additional review from another user further comprises displaying a link near the review submitted by the user to add a photo of the user to the review submitted by the user.

8. The computer storage medium of claim 7 further comprising, before displaying a link near the review submitted by the user to add a photo of the user, determining that the user has not previously submitted a photo to associate with a user credential.

9. A computing system comprising:
a memory storing a first review of an item that was sent by a first user and a second review of the item that was sent by a second user;
a processor:
determining that the first review should be displayed in a first manner that is different from a second manner in which the second review should be displayed based on a determination that the first user has requested that reviews of the item be displayed; and
causing the first review to be displayed in the first manner and the second review to be displayed in the second manner.

10. The computing system of claim 9 wherein causing the first review to be displayed in the first manner and the second review to be displayed in the second manner comprises causing the first review to be displayed in a different-sized font than the second review.

11. The computing system of claim 9 wherein causing the first review to be displayed in the first manner and to the second review to be displayed in the second manner comprises causing the first review to be displayed with a different background than the second review.

12. The computing system of claim 9 wherein causing the first review to be displayed in the first manner and the second review to be displayed in the second manner comprises causing the first review to be displayed in a bolded font and the second review to be displayed in a non-bolded font.

13. The computing system of claim 9 wherein causing the first review to be displayed in the first manner and the second review to be displayed in the second manner comprises causing the first review to be displayed higher in a list of reviews than the second review regardless of when the first review was sent by the first user.

14. The computing system of claim 13 wherein causing the first review to be displayed higher in the list of reviews than the second review regardless of when the first review was sent by the first user further comprises causing the first review to be displayed higher in the list of reviews than the second review regardless of any ratings in the first review.

15. The computing system of claim 9 wherein the determination that the first user has requested that reviews of the item be displayed comprises:
determining that a session identifier is associated with a unique user identifier;
determining that the unique user identifier matches a unique user identifier with the first review.

16. The computing system of claim 9 wherein the processor further:
receives the first review sent by the first user;
identifies a unique user identifier that is to be associated with the first review; and
stores the first review in the memory such that the first review is associated with the unique user identifier in the memory.

17. A method comprising:
serving instructions to a client to display a review received from a user and at least one additional review received from another person so as to highlight the review received from the user relative to the at least one additional review in response to a request for a page being made under a credential assigned to the user.

18. The method of claim 17 wherein serving instructions to a client to display a review received from the user and at least one additional review received from another person so as to highlight the review received from the user relative to the at least one additional review comprises serving instructions to use a different background when displaying the review received from the user than when displaying the at least one additional review received from another person.

19. The method of claim 18 further comprising serving instructions to the client so that a link to add a review is not displayed with the review received from the user.

20. The method of claim 18 wherein serving instructions to a client to display a review received from a user and at least one additional review received from another person so as to highlight the review received from the user relative to the at least one additional review comprises serving instructions to the client to display the review received from the user in a darker font than at least one additional review received from another person.
